(19) United States
(12) Patent Application Publication
(10) Pub. No.: US 2018/0259112 A1
(43) Pub. Date: Sep. 13, 2018

(54) VALVE WITH QUICK LOADER ACCESS PORT SYSTEM AND METHOD

(71) Applicants: Ming Jin Huang, Oubei, Yongjia (CN); Jian Ou Pan, Oubei, Yongjia (CN); Jian Wei Ye, Oubei, Yongjia (CN)

(72) Inventors: Ming Jin Huang, Oubei, Yongjia (CN); Jian Ou Pan, Oubei, Yongjia (CN); Jian Wei Ye, Oubei, Yongjia (CN)

(21) Appl. No.: 15/833,901

(22) Filed: Dec. 6, 2017

Related U.S. Application Data
(60) Provisional application No. 62/469,149, filed on Mar. 9, 2017.

(51) Int. Cl. F16L 55/40; F16L 55/38; F16L 55/46

(52) U.S. Cl. CPC F16L 55/40; F16L 2101/12; F16L 55/46; F16L 55/38

(57) ABSTRACT

The valve for use in cleaning pipeline systems includes an access port in the body; access port having an opening and configured to receive a cleaning element; a latching mechanism; the latching mechanism being coupled to the access port and having an open configuration and a closed configuration; a locking pin; the locking pin coupled to the latching mechanism and configured to keep the latching mechanism in the closed configuration; an integrated pressure-alert valve; the integrated pressure-alert valve configured to keep the latching mechanism in a temporarily locked condition. Valve is useful for wherein the open configuration allows access to the access port opening when the latching mechanism is in an unlatched and opened state; wherein the closed configuration prevents access to the access port opening when the latching mechanism is in a latched and closed state; and wherein the valve is configured to be used in cleaning pipeline systems.

### CROSS-REFERENCE TO RELATED APPLICATION(S)

The present application is related to and claims priority to U.S. Provisional Patent Application No. 62/469,149 filed Mar. 9, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of valves of existing art and more specifically relates to a valve for use in cleaning pipeline systems.

### RELATED ART

Pipeline systems need regular cleaning to maintain pipe integrity. This is typically done without stopping the flow of the product in the pipeline. The process is referred to as ‘pigging’. Pigging can be used for almost any section of the transfer process between, for example, blending, storage or filling systems. Pigging systems are already installed in industries handling products as diverse as lubricating oils, paints, chemicals, toiletries, cosmetics and foodstuffs. Current pig valve technology used to open an access port is generally complicated and time consuming. Additionally, the opening mechanism is subject to corrosion and damage and the valve's seal is subject to leakage and damage, which can be expensive for pipeline companies to replace. Additionally, current pig valve technology does not have any way to detect the presence of pressure in the pig valve. A suitable solution is desired.

U.S. Pat. No. 8,225,809 to Lee A. Krywitsky relates to a methods and apparatus for introducing a pig into a fluid system. The described methods and apparatus for introducing a pig into a fluid system includes an apparatus for introducing a pig into a fluid system. The method comprises providing a coupling in a fluid system. The coupling itself can include a sleeve coupled to a pipe and an end cap. The end cap may include a collar handle and at least one engagement member. The engagement member facilitates selective engagement of the end cap with the sleeve. The end cap is rotated relative to the sleeve to disengage the engagement member from the groove and to open the end cap relative to the sleeve. The groove is configured so that the engagement member can be opened only when the line is de-pressurized. A pig is inserted through the sleeve and into the pipe. The end cap is then coupled to the sleeve by engaging the engagement member with the sleeve and rotating the end cap relative to the sleeve.

### SUMMARY OF THE INVENTION

In view of the foregoing disadvantages inherent in the known valve art, the present disclosure provides a novel valve with a quick loader access port system and method. The general purpose of the present disclosure, which will be described subsequently in greater detail, is to provide a valve with a quick loader access port system and method.

A valve for use in cleaning pipeline systems is disclosed herein. The valve for use in cleaning pipeline systems includes a body (of the pig valve) having an access port, the access port having an opening and configured to receive a cleaning element (a pig or the like); a latching mechanism; the latching mechanism being coupled to the access port and having an open configuration and a closed configuration; a locking pin; the locking pin coupled to the latching mechanism and configured to keep the latching mechanism in the closed configuration; an integrated pressure-alert valve; the integrated pressure-alert valve configured to keep the latching mechanism in a temporarily locked condition; wherein the open configuration allows access to the access port opening when the latching mechanism is in an unlatched and opened state; wherein the closed configuration prevents access to the access port opening when the latching mechanism is in a latched and closed state; and wherein the valve is configured to be used in cleaning pipeline systems. The inside surface of the door preferably has a smooth face; the face being concave such that the ported ball-valve able to rotate 90 degrees along a vertical axis without contacting the face of the door to arrest fluid (liquid or other) flow and open the door to insert a pig cleaning element. When the system has been closed again the pig is rotated in the ball-valve and the ball-valve is turned 90 degrees and the door shut such that the pig can be sent down the pipeline to effect a cleaning of the pipeline walls.

According to the valve for use in cleaning pipeline systems, a method of use is also disclosed herein. The method of using a valve for use in cleaning pipeline systems includes steps of providing a valve for use in cleaning pipeline systems, keeping the latching mechanism in a temporarily locked condition; relieving the pressure another embodiment, a method of use including manually unlocking the latching mechanism; allowing access to the port opening; and using a cleaning element to clean the pipe system. The ball valve is able to be turned such that the fluid flow is stopped and the pig directed to the open pipeline.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a valve with quick loader access port system and method, constructed and operative according to the teachings of the present disclosure.

FIG. 1 is a perspective view of the valve, according to an embodiment of the disclosure.

FIG. 2 is a front view of the valve, according to an embodiment of the present disclosure.

FIG. 3 is a top view of the valve of FIG. 1, according to an embodiment of the present disclosure.

FIG. 4 is a cross-sectional view of the valve of FIG. 1, according to an embodiment of the present disclosure.

FIG. 5 is a flow diagram illustrating a method of use of the valve of FIG.1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a valve and more particularly to a valve with quick loader access port system and method as used to improve the valve for use in cleaning pipeline systems.

Generally, a pig valve is used in pipeline pigging (cleaning) operations as an access port for insertion and extraction of the cleaning pig. The quick loader access port allows for easy and quick opening of the valve for insertion and extraction of the pig. The integrated pressure alert valve advises that pressure is or is not present in the pig valve and if pressure is present, will relieve the pressure, unlock the quick loader port and allow access to the port opening. The quick loader access port opens with just a 40 degree turn of the handle, while current products use a threaded cap requiring many turns of the cap to open. The integrated pressure alert valve locking system prevents opening while under pressure. Current products do not necessarily have an integrated system.

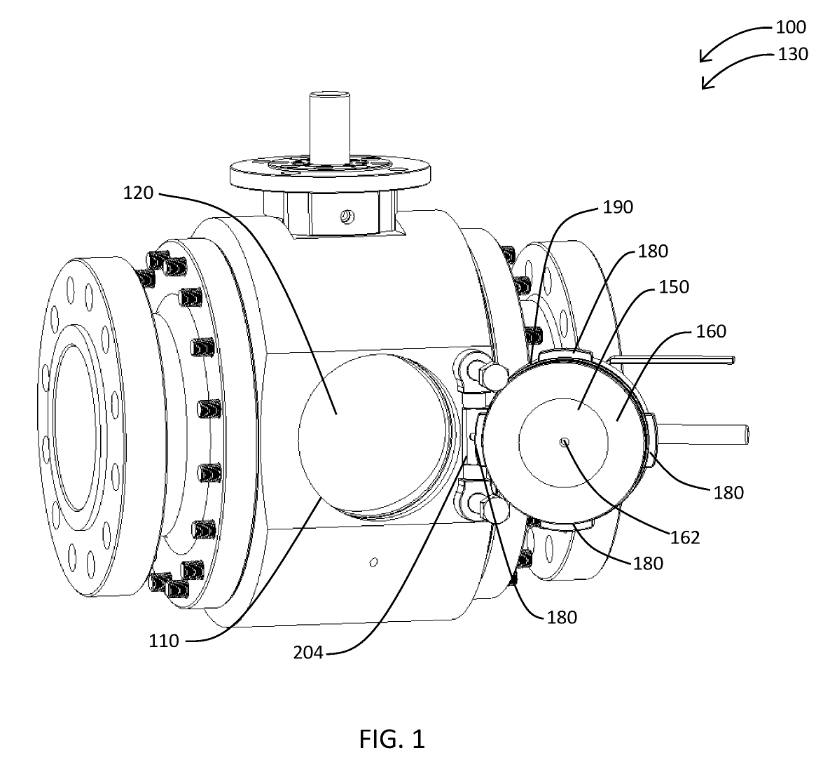

Referring now more specifically to the drawings by numerals of reference, there is shown in FIGS. 1-4, various views of a valve 100.

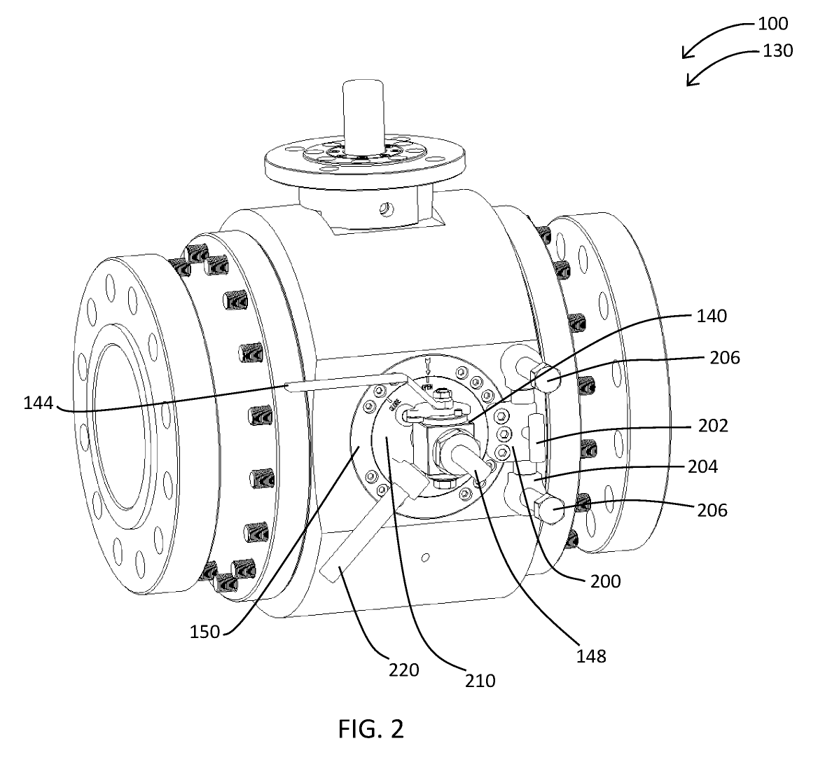

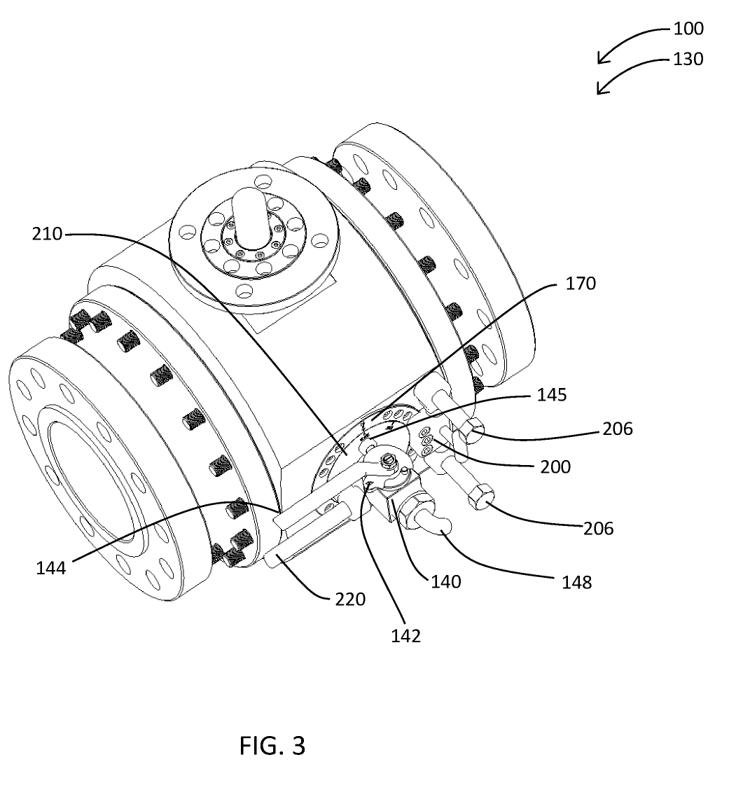

FIG. 1 is a prospective view of the valve 100 and FIG. 2 shows a front view of the valve 100 of FIG. 1, according to an embodiment of the present disclosure. Here, the valve 100 may be beneficial for use by a user for quick access while inserting or retrieving a cleaning element used in a pig valve for cleaning pipeline systems. As illustrated, the valve 100 may include a modified pig valve 100 with an added body side access port 110 of a compact design for use in cleaning pipeline systems, the valve 100 comprising: an access port 110, the access port 110 may be defined as an opening 120 configured to receive a cleaning element (a pig or the like). The opening 120 may also include a latching mechanism 130, the latching mechanism 130 being coupled to the access port 110 and may be configured to provide an open configuration as shown in FIG. 1 and a closed configuration as shown in FIG. 2. Additionally, a locking pin 145 as described in FIG. 3 may be coupled to the latching mechanism 130 configured to keep the latching mechanism 130 in a closed configuration as illustrated in FIG. 2

As shown in FIG.1 the latching mechanism 130 is in the open configuration and allows access to the access port 110 opening 120. The access port 110 opening 120 may only be provided when the latching mechanism 130 is in an unlatched and open state. It is further understood by one skilled in the art that when the access port 110 is in the closed configuration it will respectively prevent access to the access port 110 opening 120 when the latching mechanism 130 is in a latched and closed state as shown in FIG. 2

Still referring to FIG.1 a quick loader access port pig valve 100 configured to be used in cleaning pipeline systems, the latching mechanism 130 includes a latch door 150, the latch door 150 having an inside surface 160 and an outside surface 170. The inside surface 160 may have a smooth face and the smooth face is circular in shape. The latch door 150 may also include a plurality of tabs 180 coupled to an outer diameter 190 of the latch door 150.

According to an embodiment of the present disclosure the inside surface 160 of the latch door 150 may further include concave center portion as shown in FIG. 1. Additionally, a cavity relief port 162 that allows pressure contained in the ball bore (not shown) of the pig valve 100 to be relieved via a flow passage (not shown) to the integrated pressure-alert valve shown in FIG. 2.

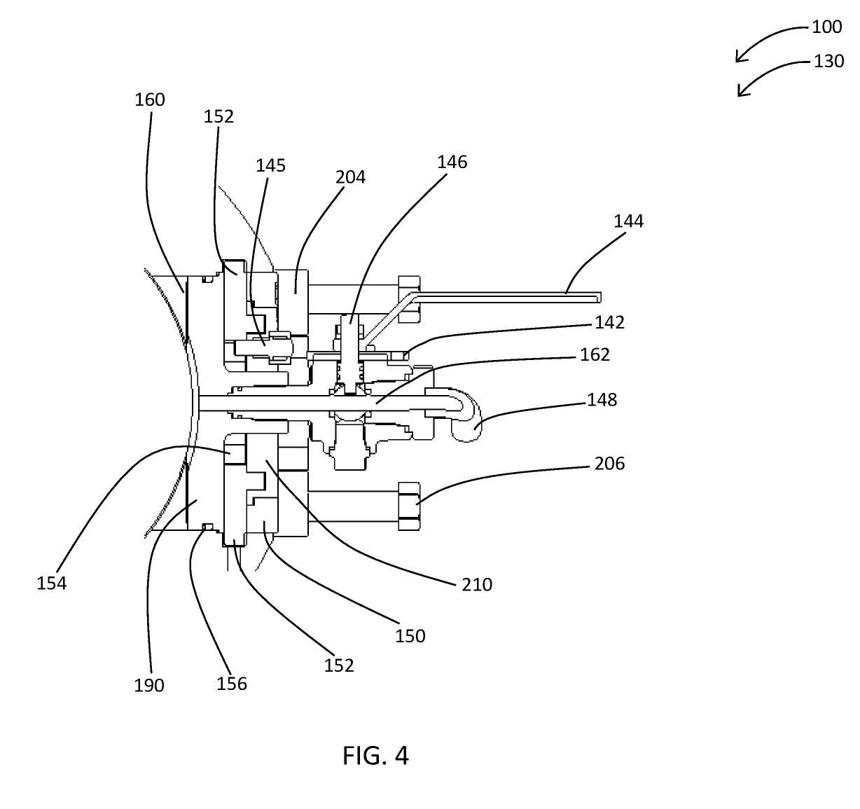

Further referring to FIG.1 according to an embodiment of the present disclosure the latch door 150 may be configured to include a hollow cavity 154 configured to house the plurality of tabs 180 and the plurality of tabs 180 may be coupled to internal cams or incline slide actuators 152 in working combination (shown in FIG. 4). Respectively in an embodiment of the present disclosure the plurality of tabs 180 and internal cams or incline slide actuators 152 may be structured and arranged such that plurality of tabs 180 may be partially expelled from the hollow cavity 154 in the latch door 150 to engage with the walls of the opening 120 by rotating the handle 220 on the latch door 150 in a counter-clockwise direction and disengaging the plurality of tabs 180 from the walls of the opening 120 only if pressure contained in the ball bore of the pig valve 100 is relieved via the integrated pressure-alert valve 140 shown in FIG. 2.

FIG. 2 shows a front view of the valve 100 of FIG. 1, according to an embodiment of the present disclosure. As above, the valve 100 may include pig valve 100 (with a body) with an added body side access port 110 of a compact design for use in cleaning pipeline systems. The valve 100 comprises an access port 110. The access port 110 may be defined as an opening 120 configured to receive a cleaning element. The opening 120 may also include a latching mechanism 130 the latching mechanism 130 further includes an arm 200 configured to pivotally close access to said access port opening 120. The arm 200 being coupled to the access port 110 and may be configured to provide an open configuration as shown in FIG. 1 and a closed configuration as shown in FIG. 2.

The latching mechanism 130 includes a latch door 150 having an inside surface 160 and an outside surface 170. The latching mechanism 130 further may include an arm 200, the arm 200 is configured to pivotally close access to the access port opening 120 and the arm 200 may be removably attached to the exterior of the pig valve 100 body adjacent to the access port 110. According to an embodiment of the present disclosure the arm 200 may be integral to the latch door 150 and may further include a pivot. In other embodiments the arm 200 may be coupled to the latch door 150. It may be further envisioned that the arm 200 may include a two dimensional hinge 204 removably coupled to modified pig valve 100 body approximant to the access port 110 using shouldered treaded fasteners 206 and as shown in FIG. 2, and the arm 200 may further include a T-handle 202 that may be integral to the arm 200 or threadably affixed to the arm 200, to provide stability during linear movement of the two dimensional hinge 204 along the fasteners 206 when the latch door 150 is traversed from an open configuration and a closed configuration or vice-versa. Movement when opening is sliding followed by swinging.

Continuing with FIG. 2 showing the outside surface 170 includes a hub element 210, the hub element 210 located centrally to the outside surface 170 of the latch door 150. According to an embodiment of the present disclosure the hub element 210 is raised with respect to the outside surface 170. Additionally, the hub element 210 includes a locking pin 145, the locking pin 145 interfaces with latching mechanism 130 and is configured to keep the latching mechanism 130 in the closed configuration. A handle 220 is configured to latch and unlatch the latch door 150. Accordingly, the handle 220 unlatches the latch door 150 by moving the handle 220 in an approximately 40-degree counter-clockwise direction. Respectively handle 220 latches the latch door 150 by moving the handle 220 in an approximately 40-degree clockwise direction.

In the center of the hub element 210 an integrated pressure-alert valve may be coupled to the latch door 150. The integrated pressure-alert valve prevents the latch door 150 from being opened while said valve 100 is under pressure. As detailed in FIG.2 there is a cavity relief port 162 that allows pressure contained in the ball bore of the pig valve 100 to be relieved via a flow passage to the integrated pressure-alert valve 140 coupled to the outside surface 170 of the latch door 150 as shown in FIG. 1.

The integrated pressure-alert valve 140 is configured to keep the latching mechanism 130 in a temporarily locked condition until such time that the pressure alert valve 140 is manually opened, thus relieving internal pressure, and further disengaging the lock pin and allowing the unlocking of the latching mechanism 130. As shown in FIG. 2 the integrated pressure-alert valve 140 may further include a directional exhaust tube 148 to direct released pressure in a preferred direction and away from the operator. The integrated pressure-alert valve 140 when in the closed configuration prevents access to the access port opening 120 when the latching mechanism 130 is in a latched and closed state. Alternately, the integrated pressure-alert valve 140 when in the open configuration allows access to the access port opening 120 when the latching mechanism 130 is in an unlatched and open state. The integrated pressure-alert valve 140 prevents the latch door 150 from being opened while the valve 100 is under pressure.

FIG. 3 is a top perspective view of the valve 100 of FIG. 1, according to an embodiment of the present disclosure. As stated above a locking pin 145 is coupled to the latching mechanism 130, more specifically the locking pin 145 may be coupled to the hub element 210 as shown in FIG. 2 and FIG. 3. In one embodiment of the present disclosure the locking pin 145 may be adapted to be interfaced with the internal cams or incline slide actuators 152 housed within the hollow cavity 154 of the latch door 150.

Additionally, the integrated pressure-alert valve 140 may be configured to comprise a modified ball valve having a cam-shaped stop plate 142 and a manual pressure relief fulcrum 144 coupled to the axial shaft 146 and including a directional exhaust tube 148 and wherein the cam-shaped stop plate 142 is structured and arranged to overcome the biasing force of the locking pin 145.

FIG. 4 is a cross-sectional view of the valve 100 of FIG. 1, according to an embodiment of the present disclosure. The latching mechanism 130 includes a latch door 150, the latch door 150 having an inside surface 160 and an outside surface 170. The latching mechanism 130 further may include an arm 200. The arm 200 is configured to pivotally close access to said access port 110 opening 120 and the arm 200 may be removably attached to the exterior of the modified pig valve 100 body adjacent to the access port 110. As above, it may be further envisioned that the arm 200 may include a two-dimensional hinge 204 removably coupled to pig valve body 100 adjacent to the access port 110 using preferably shoulder threaded fasteners 206.

Continuing with FIG. 4 showing the outside surface 170 includes a hub element 210, the hub element 210 located centrally to the outside surface 170 of the latch door 150. According to an embodiment of the present disclosure the hub element 210 is raised with respect to the outside surface 170. Additionally, the hub element 210 includes a locking pin 145, the locking pin 145 interfaces with latching mechanism 130 and is configured to keep said latching mechanism 130 in said closed configuration. T-handles 202 may be used to effectuate controlled and guided movement when opening the door (latch door).

Located in the center of the hub element 210 an integrated pressure-alert valve may be coupled to the latch door 150. The integrated pressure-alert valve prevents the latch door 150 from being opened while said valve 100 is under pressure. As detailed in FIG. 1 there is a cavity relief port 162 that allows pressure contained in the ball bore of the pig valve 100 to be relieved via a flow passage to the integrated pressure-alert valve 140 coupled to the outside surface 170 of the latch door 150. As shown in FIGS. 2 & 3 the integrated pressure-alert valve 140 may further include a directional exhaust tube 148 to direct released pressure in a preferred direction and away from the operator. As stated above a locking pin 145 is coupled to the latching mechanism 130. More specifically, the locking pin 145 may be coupled to the hub element 210 as shown in FIG. 2 and FIG. 3. In one embodiment of the present disclosure the locking pin 145 may be adapted to be interfaced with the internal cams or incline slide actuators 152 housed within the hollow cavity 154 of the latch door 150.

Additionally, the integrated pressure-alert valve 140 may be configured to comprise a modified ball valve having a cam-shaped stop plate 142 and a manual pressure relief fulcrum 144 coupled to the axial shaft 146 and configured such that the cam-shaped stop plate 142 is structured and arranged to overcome the biasing force of the locking pin 145. Additionally, as shown in FIG. 4 the latch door 150 includes a pressure resistant seal 156.

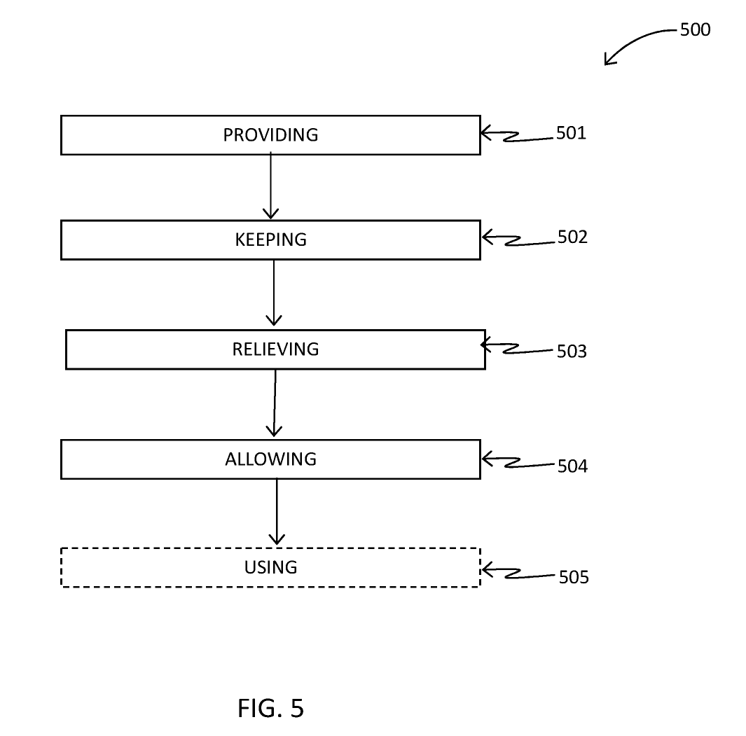

FIG. 5 is a flow diagram illustrating a method for use of valve 100, according to an embodiment of the present disclosure. In particular, the method of use 500 for valve 100 may include one or more components or features of the valve 100 as described above. As illustrated, the method for use of the valve 500 may include the steps of: step one 501, providing a valve 100, the valve 100 having an access port 110, the access port 110 having an opening 120 and configured to receive a cleaning element; a latching mechanism 130, the latching mechanism 130 being coupled to the access port 110 and having an open configuration and a closed configuration; an integrated pressure-alert valve 140, the integrated pressure-alert valve 140 configured to keep the latching mechanism 130 in a temporarily locked condition in the valve 100; wherein the open configuration allows access to the access port 110 opening 120 when the latching mechanism 130 is in an unlatched and opened state; wherein the closed configuration prevents access to the access port 110 opening 120 when the latching mechanism 130 is in a latched and closed state; step two 502, keeping the latching mechanism 130 in a temporarily locked condition in the valve 100 by the integrated pressure-alert valve 140; step three 503, relieving the pressure manually; step four 504, allowing access to the port opening 120; and step five 505, using a cleaning element to clean the pipe system. Those with ordinary skill in the art will now appreciate that upon reading this specification and by their understanding the art of closure fasteners as described herein, methods of use of fasteners of different types may be employed and will be understood by those knowledgeable in such art.

It should be noted that step 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for valve 100 for use in cleaning pipeline systems are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A valve system, the valve system comprising:
a pig valve assembly with a body having,
an access port, said access port having an opening configured to receive a cleaning element;
a latching mechanism, said latching mechanism being coupled to said access port allowing movement between an open configuration and a closed configuration;
a locking pin, said locking pin coupled to said latching mechanism and configured to keep said latching mechanism in said closed configuration;
a ported ball-valve able to rotate 90 degrees along a vertical axis within said body such that fluid flow can be stopped when opening said access port for maintenance and alternately said fluid flow is allowed during regular pipeline flow;
an integrated pressure-alert valve, said integrated pressure-alert valve configured to keep said latching mechanism in a temporarily locked condition;
wherein said open configuration allows access to said access port opening when said latching mechanism is in an unlatched and opened state;
wherein said closed configuration prevents access to said access port opening when said latching mechanism is in a latched and closed state; and
wherein said valve is configured to be used in cleaning pipeline systems.

2. The valve system of claim 1, wherein said latching mechanism includes a latch door, said latch door having an inside surface and an outside surface.

3. The valve system of claim 2, wherein said inside surface has a smooth face and a portion of said face is concave.

4. The valve system of claim 3, wherein said smooth face is circular in shape.

5. The valve system of claim 2, wherein said latch door includes a plurality of tabs interfaced to an outer diameter of said latch door such that the tabs can be actuated by a camming system to allow locking to occur.

6. The valve system of claim 2, wherein said latching mechanism further includes an arm, said arm being removably attached to said access port.

7. The valve system of claim 6, wherein said arm is coupled to said outside surface of said latch door.

8. The valve system of claim 6, wherein said arm is configured to pivotally close access to said access port opening.

9. The valve system of claim 2, wherein said outside surface includes a hub element, said hub element located centrally to said outside surface.

10. The valve system of claim 9, wherein said hub element is raised with respect to said outside surface.

11. The valve system of claim 9, wherein said hub element includes a handle.

12. The valve system of claim 11, wherein said handle is configured to latch and unlatch said latch door.

13. The valve system of claim 12, wherein said handle unlatches said latch door by moving said handle in an approximately 40-degree counter-clockwise direction.

14. The valve system of claim 12, wherein said handle latches said latch door by moving said handle in an approximately 40-degree clockwise direction.

15. The valve system of claim 1, wherein said integrated pressure-alert valve prevents said latch door from being opened while said valve is under pressure.

16. The valve system of claim 1, wherein said valve is made from a material selected from the group consisting of various grades of carbon steel, alloy steel, various grades of stainless steel, and various grades of corrosion-resistant steel.

17. A valve system for use in cleaning pipeline systems, said valve comprising:
a pig valve assembly with a body having an access port, said access port having an opening and configured to receive a cleaning element;
a latching mechanism on a door, said latching mechanism being coupled to said access port and having an open configuration and a closed configuration;
a ported ball-valve able to rotate 90 degrees along a vertical axis within said body such that fluid flow can be stopped when opening said access port for maintenance and alternately said fluid flow is allowed during regular pipeline flow;
a locking pin, said locking pin coupled to said latching mechanism and configured to keep said latching mechanism in said closed configuration;
an integrated pressure-alert valve, said integrated pressure-alert valve configured to keep said latching mechanism in a temporarily locked condition;
wherein said open configuration allows access to said access port opening when said latching mechanism is in an unlatched state;
wherein said closed configuration prevents access to said access port opening when said latching mechanism is in a latched state;
wherein said latching mechanism includes a latch door, said latch door having an inside surface and an outside surface;
wherein said inside surface of said door has a smooth face, said face being concave such that said ported ball-valve able to rotate 90 degrees along said vertical axis without contacting said face of said door to arrest said fluid flow and open said door to insert a pig said cleaning element;
wherein said smooth face is circular in shape;
wherein said latch door includes a plurality of tabs interfaced with an outer diameter of said latch door;
wherein said latching mechanism further includes an arm, said arm being removably attached to said access port;
wherein said arm is coupled to said outside surface of said latch door;
wherein said arm is configured to pivotally close access to said access port opening;
wherein said outside surface includes a hub element, said hub element located centrally to said outside surface;
wherein said hub element is raised with respect to said outside surface;
wherein said hub element includes a handle;
wherein said handle is configured to latch and unlatch said latch said door;
wherein said handle unlatches said latch said door by moving said handle in an approximately 40-degree counter-clockwise direction;
wherein said handle latches said latch said door by moving said handle in an approximately 40-degree clockwise direction;
wherein said integrated pressure-alert valve prevents said latch said door from being opened while said valve is under pressure; and
wherein said handle latches said latch door by moving said handle in a 40-degree counter-clockwise direction; and wherein said integrated pressure-alert valve prevents said valve from opening while under pressure.

18. A method for cleaning pipeline systems, said method comprising:
providing a valve, said valve having an access port, said access port having an opening configured to receive a cleaning element; a latching mechanism, said latching mechanism being coupled to said access port and having an open configuration and a closed configuration; an integrated pressure-alert valve, said integrated pressure-alert valve configured to keep said latching mechanism in a temporarily locked condition in said valve; wherein said open configuration allows access to said access port opening when said latching mechanism is in an unlatched and opened state; wherein said closed configuration prevents access to said access port opening when said latching mechanism is in a latched and closed state;
keeping said latching mechanism in a temporarily locked condition in said valve by said integrated pressure-alert valve;
turning a ported ball-valve 90 degrees to arrest flow;
relieving said pressure manually;
unlocking said latching mechanism;
opening said latching mechanism in relation to said access port;
allowing access to said port opening; and
using a cleaning element to clean said pipe system after said ported ball-valve is turned another 90 degrees.
